(19) United States
(12) Patent Application Publication
(10) Pub. No.: US 2016/0325770 A1
(43) Pub. Date: Nov. 10, 2016

(54) HYDRAULIC DOLLY AND METHOD OF USE

(71) Applicant: JEROME WILCOX, ST. GEORGE, UT (US)

(72) Inventor: JEROME WILCOX, ST. GEORGE, UT (US)

(21) Appl. No.: 15/147,725

(22) Filed: May 5, 2016

Related U.S. Application Data
(60) Provisional application No. 62/157,845, filed on May 6, 2015.

(51) Int. Cl. B62B 1/14; B62B 5/00

(52) U.S. Cl. CPC B62B 1/14; B62B 5/0003; B62B 2207/00

(57) ABSTRACT

A hydraulic dolly has an outer frame, a vertical lifting frame, a pair of wheels attached at the base of the outer frame, a lifting platform extending perpendicular from the base of the vertical lifting frame, and a hydraulic jack for raising and lowering the lifting platform.

A system for moving objects uses at least two hydraulic dollies, wherein the dollies each comprise an outer frame, a vertical lifting frame, a pair of wheels attached at the base of the outer frame, a lifting platform extending perpendicular from the base of the vertical lifting frame, and a hydraulic jack for raising and lowering the lifting platform, and a means for connecting the at least two dollies together.

### CROSS-REFERENCE TO RELATED APPLICATIONS

This application claims the benefit of U.S. Provisional Application Ser. No. 62/157,845, filed on May 6, 2015, which is incorporated herein by reference.

### TECHNICAL FIELD

The present disclosure relates generally to hand trucks. More particularly, the present disclosure relates to hand trucks with hydraulic lifting systems.

### BACKGROUND

Hand trucks (also referred to herein as a “dolly” or “dollies”), have been used to move heavy objects for a very long time. There are generally two types of standard dollies: 1) an L-shaped lever with two wheels at the fulcrum; and 2) a 4-wheeled dolly that is usually just a rectangular base with 4 wheels, but may also have one or more handles extending therefrom.

Specialized dollies have been invented for the purpose of moving bulky and especially heavy items such as fridges, washing machines, filing cabinets, and others. For example, these appliance dollies typically have straps for securing the item to be moved, a pair of rotating belts for use with stairs, and may even have an additional leg extension for easing the weight being balanced by the user. However, all of these dollies require a user to physically lift the item to be moved by using the handles of the dolly like a lever. This may be difficult for one user to accomplish, and impossible in many scenarios. Once balanced on the fulcrum, the user must then maintain the delicate balance while attempting to negotiate turns, or other obstacles, while moving the object to the new location. For large objects, this is also very difficult and dangerous and may result in injury to the user, the object, or the facility.

In the alternative, a user may choose to use a 4-wheeled dolly. This has several benefits, including the ability to easily maneuver the object without balancing its weight on a fulcrum. It also allows one user to more easily move an object and negotiate turns without the heightened risk of injury. However, one severe limitation is the ability of a user to initially lift the object onto the dolly. Further, some objects are too difficult for even two users to lift safely onto a 4-wheeled dolly, which may cause them to resort to a 2-wheeled dolly as mentioned above.

Therefore, there remains a need for a dolly and system that can carry large, heavy, and awkward objects without risk of injury from lifting and/or balancing. The present disclosure seeks to solve these and other problems.

### SUMMARY OF EXAMPLE EMBODIMENTS

In one embodiment, a hydraulic dolly comprises an outer frame, an inner frame, a pair of wheels attached at the base of the outer frame, a lifting platform extending perpendicular from the base of the inner frame, and a hydraulic system for raising and lowering the platform.

In one embodiment, a system for moving objects comprises at least two hydraulic dollies, wherein the dollies each comprise an outer frame, an inner frame, a pair of wheels attached at the base of each outer frame, a lifting platform extending perpendicular from the base of the inner frame, a hydraulic system for raising and lowering the platform, and a means for connecting the at least two dollies together.

### BRIEF DESCRIPTION OF THE DRAWINGS

FIG. 1 is a perspective view of a hydraulic dolly;

FIG. 2 is a side elevation view of a hydraulic dolly;

FIG. 3 is a back elevation view of a hydraulic dolly; and

FIG. 4 is a side view illustrating a method of using two hydraulic dollies to easily move furniture.

### DETAILED DESCRIPTION OF EXAMPLE EMBODIMENT(S)

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” does not necessarily refer to the same embodiment, although it may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

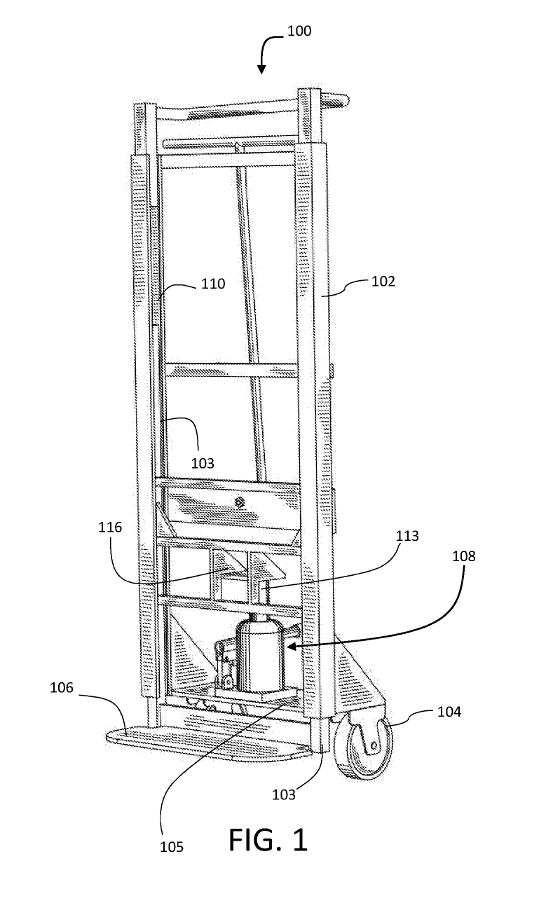

In general, as illustrated in FIG. 1-3, a hydraulic dolly 100 comprises an outer frame 102, a pair of wheels (or casters) 104 connected or otherwise coupled to the base of the outer frame 102 and proximal to a user, a lifting platform 106 extending perpendicular from the base of the outer frame 102 and connected to a vertical lifting frame 103, and a lifting means 108 for raising and lowering the platform 106. The outer frame 102, vertical lifting frame 103, and platform 106 may be manufactured from a variety of materials, including aluminum, metals, steel, or other sufficiently rigid materials for lifting and moving heavy objects.

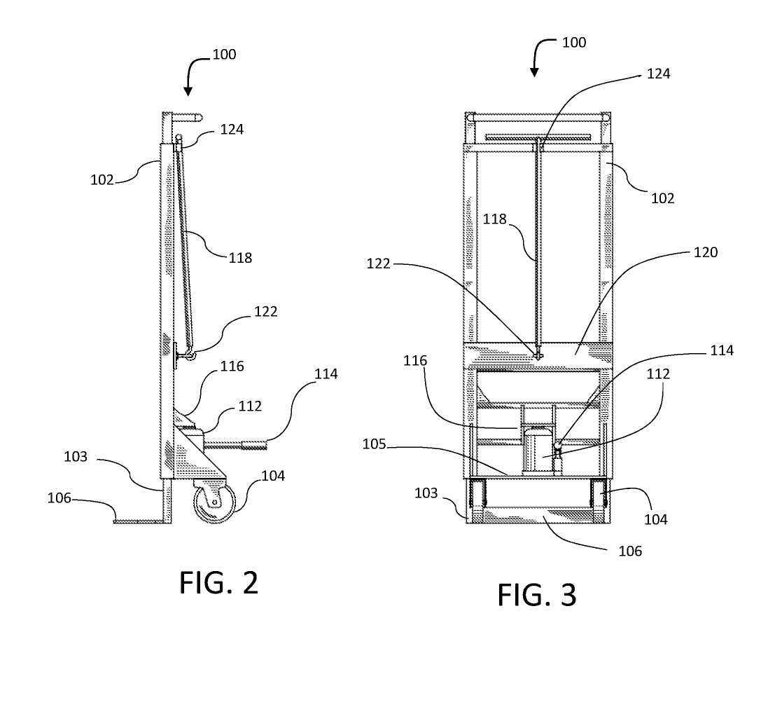

In one embodiment, the lifting means 108 comprises a hydraulic jack 112 (best seen in FIGS. 2 & 3) operably connected to the vertical lifting frame 103, such as by using one or more braces 116. As the hydraulic jack 112 is actuated by a user using lever 114, the piston 113 raises, which thereby raises braces 116, causing the vertical lifting frame 103 to raise, which thereby raises lifting platform 106. In one example of use, a user would ensure that platform 106 is proximal to the ground by actuating a releasing means (e.g., by rotating the lever arm 114 or by otherwise releasing the pressure in the jack) and applying downward force to the platform 106 if needed to lower it proximal to the ground. In one embodiment, the downward force may be accomplished using one or more coil springs attached to the vertical lifting frame 103 or braces 116 and the base 105. Further, they hydraulic jack 112 is mounted on the base 105. A user would then slide or otherwise maneuver the platform 106 under an object to be moved. A user would then actuate lever arm 114, which engages the jack 112, which, being connected to the vertical lifting frame 103, such as by using brace 116, causes the vertical lifting frame 103 to slide within channels 110 of outer frame 102, lifting the platform 106 vertically. As the platform 106 raises vertically, the object is lifted from the ground. It will be appreciated that while the vertical lifting frame 103 is shown as connecting to the lifting platform 106 on the sides, the vertical lifting frame 103 may in fact be configured to be a solid frame, connecting to the platform 106 across the entire back side of the platform 106, so as to create additional strength. Further, the lifting platform 106 and the vertical lifting frame 102 may be of one single manufacture. In other words, a solid sheet of steel (or other material) may be bent or welded so as to create the “L” shape of the platform-vertical frame configuration. The upper portion, or vertical lifting frame, would then be received within the channels of the outer frame 102 and would be connected to the jack using braces 116. This is just one alternative configuration that may be used for the platform 106 and the vertical lifting frame. It is intended that the vertical lifting frame be a coupling means between the platform and the hydraulic jack, and that such vertical lifting frame could be any number of configurations while achieving the same result. As such, such changes to the vertical lifting frame are contemplated herein.

The hydraulic jack 112 may be one of any number of hand-actuated jacks, such as a floor jack or trolley jack, a farm jack (a.k.a. Hi-Lift jack), strand jack, or pallet jack—all of which are well-known in the art. When not in use, the lever arm 114 may be secured to either the vertical lifting frame 103 or the outer frame 102 using a securing means, such as clips, brackets, tension, straps, etc. Further, a dolly handle 118 allows a user to pull and steer the dolly when in use to move an object. The handle 118 may be removable attachable to a handle frame 120, which is connected to the outer frame 102. The handle 118 is hingedly attached to the handle frame 120 so as to allow the user to use the handle 118 at varying heights. This may be accomplished in a variety of manners, such as by using hinges, springs, or, as shown, a hook and loop system 122. The hook and loop system 122 allows the handle 118 to rotate to a plethora of angles without restriction. Further, the top of the handle 118 may be removably attachable to the outer frame 102, such as using a tension clip 124. This allows the handle 118 to be stored vertically when not in use.

In another embodiment, not illustrated, the lifting means comprises a geared rack with a lever and a ratcheting mechanism coupled to the base of the lever handle. The lever handle and ratcheting mechanism are configured such that application of a force about the end of the lever handle causes the ratcheting mechanism to engage a gear, thus causing the gear to rotate and therefore lift the platform vertically along the geared rack. The ratchet may comprise a releasing lever, which allows the gear to freely rotate on the geared rack, which allows the platform to lower to the ground.

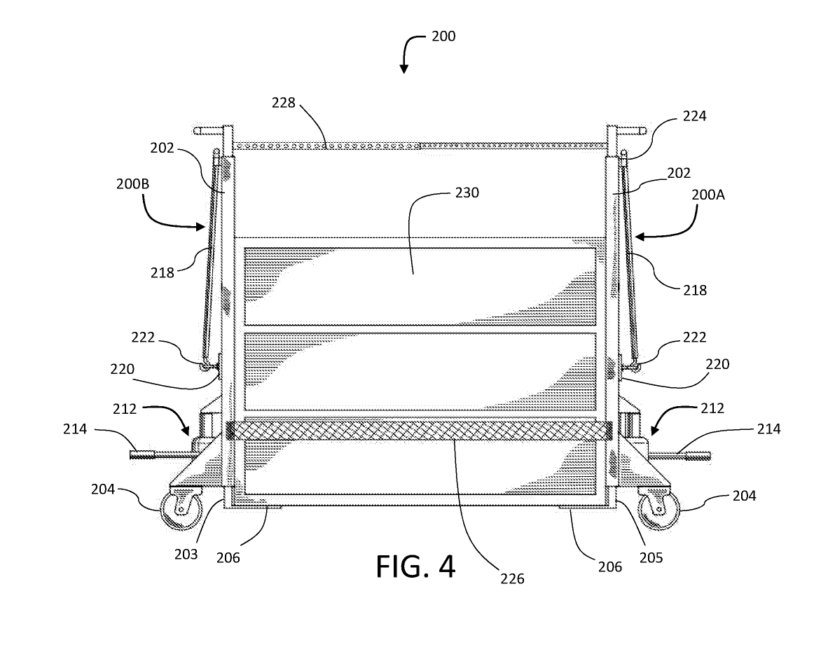

In one embodiment, as shown in FIG. 4, a system 200 for moving objects comprises at least two hydraulic dollies 200A, 200B, wherein the dollies 200A, 200B each comprise an outer frame 202, a pair of wheels 204, a lifting platform 206 extending perpendicular from the base of the outer frame 202 and connected to a vertical lifting frame 203, a hydraulic system 212 with a lever arm 214 for raising and lowering the platform 206, and a means for connecting the at least two dollies together. The means for connecting the dollies may comprise one or more straps 226 or stabilization bars 228 or both. In one embodiment, a dolly stabilization bar 228 connects the at least two dollies 200A, 200B together such that when an object 230 is moved, the dollies 200A, 200B do not substantially tilt or angle in an unwanted way. Further, each hydraulic dolly 200A, 200B may have a handle 218 allowing a user to pull and steer the system 200 when in use to move an object 230. The handle 218 may be removably attachable to a handle frame 220, which is connected to the outer frame 202. The handle 218 is hingedly (or rotatably) attached to the handle frame 220 so as to allow the user to use the handle 218 at varying heights. This may be accomplished in a variety of manners, such as by using hinges, springs, or, as shown, a hook and loop system 222. The hook and loop system 222 allows the handle 218 to rotate to a plethora of angles without restriction. Further, the top of the handle 218 may be removably attachable to the outer frame 202, such as using a tension clip 224. This allows the handle 218 to be stored vertically when not in use.

In one example of use, as seen in FIG. 4, a user would place one dolly 200A and 200B at opposing ends of an object 230 (e.g., a dresser) to be moved. The user would then maneuver the lifting platforms 206 underneath the object 230 and then connect or otherwise secure the two dollies 200A, 200B to each other using at least one of straps 226 or stabilization bar 228. Once secured, a user would then actuate jack lever 214 on each dolly 200A, 200B so as to raise the lifting platform 206 and thereby raise the object 230. With the object 230 raised off of the surface and securely strapped to each dolly 200A and 200B, a user can easily maneuver the dolly and the object 230 to the desired location. In one embodiment, a user may release the handle 218 from the tension clip 224, allowing the user to then guide the 4-wheeled system to the desired location more easily.

As is appreciated from the above disclosure, the present invention solves many problems in the art. In particular, use of the system 200 allows a user to transport a large object without having to either, 1) balance the object on a fulcrum, or 2) lift the object onto a convention four-wheeled platform or dolly. As such, the present invention is a major improvement over the prior art.

What is claimed is:

1. A hydraulic dolly, comprising:
an outer frame having a pair of wheels connected at the base on the side proximal to a user;
a lifting platform extending perpendicularly from the outer frame and connected to a vertical lifting frame, wherein the vertical lifting frame is receivable within channels of the outer frame; and
a hydraulic jack configured to raise the vertical lifting frame.

2. The hydraulic dolly of claim 1, further comprising one or more springs connected to the vertical lifting frame and a base.

3. The hydraulic dolly of claim 1, further comprising a removably attachable handle.

4. A method of using the hydraulic dolly of claim 1 to move an object, the method comprising:
placing a first hydraulic dolly at one end of an object;
placing a second hydraulic dolly at an opposing end of the object;
securing the first hydraulic dolly to the second hydraulic dolly;
actuating the hydraulic jack of both the first and second hydraulic dollies to lift the object; and
moving the object.

5. A hydraulic dolly, comprising:
a geared rack with a lever and a ratcheting mechanism coupled to the base of a lever handle, the lever handle and ratcheting mechanism are configured such that application of a force about the end of the lever handle causes the ratcheting mechanism to engage a gear, thus causing the gear to rotate and therefore lift a lifting platform vertically along the geared rack; the ratchet comprising a releasing lever, which allows the gear to freely rotate on the geared rack, which allows the platform to lower to the ground.

6. A system for moving objects, comprising:
placing a first hydraulic dolly at one end of an object;
placing a second hydraulic dolly at an opposing end of the object;
securing the first hydraulic dolly to the second hydraulic dolly;
actuating a hydraulic jack located on each of the first and second hydraulic dollies to lift the object; and
moving the object.

7. The system of claim 6, wherein the method of securing the first hydraulic dolly to the second hydraulic dolly comprises a strap.

8. The system of claim 6, wherein the method of securing the first hydraulic dolly to the second hydraulic dolly comprises a stabilization bar.
